(19) United States
(12) Patent Application Publication
(10) Pub. No.: US 2022/0061623 A1
(43) Pub. Date: Mar. 3, 2022

(54) Plant-Based Cleaning Scrubber

(71) Applicants: John T. Henri, Longmont (US); Evana Henri, Longmont (US)

(72) Inventors: John T. Henri, Longmont (US); Evana Henri, Longmont (US)

(21) Appl. No.: 17/460,219

(22) Filed: Aug. 28, 2021

Related U.S. Application Data
(60) Provisional application No. 63/084,552, filed on Sep. 28, 2020.
(60) Provisional application No. 63/072,140, filed on Aug. 29, 2020.

(51) Int. Cl. A47L 13/16; A01N 31/16; C11D 3/20

(52) U.S. Cl. CPC A47L 13/16; C11D 3/2068; A01N 31/16

(57) ABSTRACT

Various biobased cleaning scrubbers designed for short-term use and made from natural materials are described. Scrubbing compositions made from natural materials that are friendly to the domestic and natural environment and friendly to composting or recycling. Washing scrubbers comprising fibers mixed with a soap distributed in the fiber matrix along with microbial growth inhibitors.

### RELATED APPLICATIONS

This application claims the benefit of U.S. Provisional application No. 63/072,140 titled “Disposable Cleansing Scrub” filed Aug. 29, 2020 and U.S. Provisional application No. 63/084,552 titled “Disposable Cleansing Scrub” filed Sep. 28, 2020 which are incorporated herein by reference.

### BACKGROUND

Household cleaning sponges (scrubbers) are made up of polymeric materials that are long-lasting and durable. Unfortunately, they are also ideal for breeding and spreading harmful bacteria. In a July 2017 publication in the journal Nature, Cardinale et al demonstrated in their study that the kitchen sponge was the number one reservoir of active bacteria amongst household items. Contrary to popular perception, their research showed that a used kitchen sponge is dirtier than a used toilet brush.

While efforts have been made to develop commercial products and devices to sanitize used kitchen sponges, their effectiveness was limited at best. Some research found a general bacterial reduction of no more than 60% (Tate, 2006).

Another problem with polymer sponges is their role in the global pollution and littering. Like plastic bags and bottles, the sponges have limited potential for recycling and generally end up in the landfill and are ultimately harmful to the environment.

### SUMMARY OF THE INVENTION

Methods of inhibiting microbial growth on a cleaning sponge scrubber comprising treating the sponge with an effective amount of curcumin are described. Cleaning sponges made of biobased polymers selected from cotton, manila, sisal, jute, coconut fibers, palm fibers, hemp fibers, raffia, gourd fibers, spanish moss, coir, papyrus, sweet grass, greenbrier, cordgrass, oat straw, barley straw, rice husks/hulls, hemp straw, wheat straw, excelsior, wood shavings, and shredded wood wool from hard and soft woods including aspen, willow, neem, cotton wood, oak, palms, poplar, pine, spruce, eucalyptus. Biobased polymer employed include cellulose fiber, silk fiber or wool fiber. Scrubbers or sponges contain detergent or soap comprising hydrolyzed fatty acid, glycerol and curcumin.

Compositions of matter comprising curcumin, a plant-textile fiber, and minimally processed plant fiber for cleaning are described. Compositions, where the plant fiber is selected from cotton, manila, sisal, jute, coconut fibers, palm fibers, hemp fibers, raffia, gourd fibers, spanish moss, coir, papyrus, sweet grass, greenbrier, cordgrass, oat straw, barley straw, rice husks/hulls, hemp straw, wheat straw, excelsior and shavings from hard and soft woods including aspen, willow, neem, cotton wood, oak, palms, poplar, pine, spruce, eucalyptus. Compositions may further comprise of a detergent soap containing curcumin and the amount of curcumin is effective in inhibiting microbial growth in a cleaning sponge. The compositions may also include glycerol, clay and an essential oil.

### DESCRIPTION

Various embodiments of plant-based cleaning scrubbers (sponge) designed for short-term use are described. The sponge may be used for cleaning dishes, utensils, cookware, countertops, sinks, bathtubs, and other surface areas. The sponge may be used for washing fruits and root vegetables. The sponge may also be used for washing face and body.

In one embodiment the scrubber (sponge) is made from all-natural, plant materials (vegan) that are 100% biodegradable and environmentally friendly. The discarded used scrubber can be part of the household compost and does not require special processing. In another embodiment it may be processed by industrial composting.

In one embodiment the scrubber (sponge) consists of a fibrous material mixed with a soap distributed in the fiber matrix. The fibers may be bound into an ergonomic shape by setting the fibers and melted soap in a mold of desired shape. In one embodiment the fibers are bound together to maintain the integrity of the scrubber using strings, glue, or encasement of textile, netting, or gauze. The encasement matter may be made up of a woven, knit, printed, and like materials which are made up of biobased polymers such as cellulose, wool, silk, latex, keratin based, protein or polysaccharide based fibers, synthetic polymers such as nylon, polyester, acrylic, rayon and the like. The encasement matter may be made up of a cotton gauze. The encasement matter may be made up of a jute, hemp, cotton, silk, nylon, polyester or like natural or synthetic gauze.

In one embodiment, a method of inhibiting microbial growth in a cleaning device such as a scrubber or sponge which comprises administering thereto an effective amount of a compound of the formula:

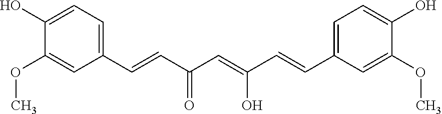 [SMILES: COc1cc(/C=C/C(=O)/C=C(O)/C=C/c2ccc(O)c(OC)c2)ccc1O]

In one embodiment, a method of inhibiting microbial growth in a cleaning device such as a scrubber or sponge which comprises administering thereto an effective amount of curcumin. Curcumin may be applied in its native form as turmeric powder. Turmeric is a common spice that comes from the root of Curcuma longa.

In some preferred embodiments turmeric powder which contains curcumin is applied to the cleaning device. In other preferred embodiments curcumin isolated from turmeric is applied to the cleaning device. The former embodiments require less processing and isolation work to purify curcumin and may be preferred in some applications. The later embodiments require some processing and isolation work to isolate curcumin from the turmeric powder and may be preferred in some applications. The isolation of curcumin from turmeric is reported in literature. See Zielińiska et al. “Properties, Extraction Methods, and Delivery Systems for Curcumin as a Natural Source of Beneficial Health Effects.” Medicina; vol. 56,7 336; 2020 for means of extraction, isolation of curcumin from turmeric which is incorporated by reference herein.

In one embodiment, a method of inhibiting microbial growth in a cleaning device such as a scrubber or sponge which comprises treating the polymeric matrix of sponge, scrubber or cleaning device with an effective amount of curcumin. The concentration of curcumin applied to the sponge is from 0.01 to 10,000 micrograms per gram weight of sponge.

The microorganisms that are inhibited from growing on the sponge include bacteria, viruses, fungi and the like found growing in domestic, commercial, outdoor recreational, scientific, military, and other environments. The sponge may be treated with an effective amount of curcumin by applying dissolved curcumin in a solvent such as ethanol, acetone, isopropanol or any other organic solvent or mixture of organic solvent with water and wetting the sponge with the solution. Wetting may be accomplished by immersion, spraying or the like means to achieve the effective concentration of curcumin. The solvent may be then evaporated to yield an inhibited microbial incubator sponge or scrubber with a resistance to microbial growth.

Curcumin antiviral and antibacterial activity was investigated, and it was shown to act against various important human pathogens like the influenza virus, hepatitis C virus, HIV and bacterial strains including staphylococcus, streptococcus, and pseudomonas. The structure of curcumin is shown below:

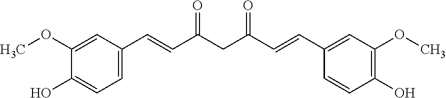

Anti-infective and microbial growth inhibiting properties of curcumin are published in a) Frontiers in Microbiology, Praditya et al; Anti-infective Properties of the Golden Spice Curcumin. Front Microbiol. 2019 May which is incorporated by reference herein, b) RSC Advances, Shlar et al, 2017, 7, 42559-42569 incorporated by reference herein.

Turmeric may be used in the equivalent amounts instead of curcumin to achieve effective results described in the embodiments herein.

In some preferred embodiments the scrubber or sponge is a composition of matter for cleaning consisting of cellulosic fibers and curcumin. In one embodiment the scrubber or sponge is a composition of matter for cleaning consisting of excelsior fiber, cotton fiber and curcumin distributed in the matrix of the fibers. In some preferred embodiments the scrubber or sponge is a composition of matter for cleaning consisting of cellulosic fibers and turmeric. In one embodiment the scrubber or sponge is a composition of matter for cleaning consisting of excelsior fiber, cotton fiber and turmeric distributed in the matrix of the fibers. In one embodiment the scrubber or sponge is a composition of matter for cleaning consisting of excelsior fiber, cotton fiber, a transition metal or alum and curcumin distributed in the matrix of the fibers. In one embodiment the scrubber or sponge is a composition of matter for cleaning consisting of excelsior fiber, cotton fiber, a transition metal or alum and turmeric distributed in the matrix of the fibers. In another embodiment the scrubber or sponge is a composition of matter for cleaning consisting of excelsior fiber, cotton fiber, a transition metal or alum, a soap mixed with curcumin or turmeric and turmeric distributed in the matrix of the fibers.

In one embodiment, the scrubber or sponge is a composition of matter for cleaning consisting of rice husks, cotton fiber and curcumin distributed in the matrix of the fibers. In one embodiment the scrubber or sponge is a composition of matter for cleaning consisting of oat straw, cotton fiber and curcumin distributed in the matrix of the fibers. In one embodiment the scrubber or sponge is a composition of matter for cleaning consisting of barley straw, cotton fiber and curcumin distributed in the matrix of the fibers. In one embodiment the scrubber or sponge is a composition of matter for cleaning consisting of coconut fiber, cotton fiber and curcumin distributed in the matrix of the fibers. In one embodiment the scrubber or sponge is a composition of matter for cleaning consisting of pine straw, cotton fiber and curcumin distributed in the matrix of the fibers. In one embodiment, the scrubber or sponge is a composition of matter for cleaning consisting of loofah, cotton fiber and curcumin distributed in the matrix of the fibers. In one embodiment, the scrubber or sponge is a composition of matter for cleaning consisting of natural wood shavings made of poplar, alder, aspen, birch, pine, spruce, oak, and beech wood, cotton fiber and curcumin distributed in the matrix of the fibers. In one embodiment, the scrubber or sponge is a composition of matter for cleaning consisting of shredded wood wool make of poplar, alder, aspen, birch, pine, spruce, oak, and beech wood, cotton fiber and curcumin distributed in the matrix of the fibers.

In one embodiment, the scrubber or sponge is a composition of matter for cleaning consisting of rice husks, cotton fiber and turmeric distributed in the matrix of the fibers. In one embodiment the scrubber or sponge is a composition of matter for cleaning consisting of oat straw, cotton fiber and turmeric distributed in the matrix of the fibers. In one embodiment the scrubber or sponge is a composition of matter for cleaning consisting of barley straw, cotton fiber and turmeric distributed in the matrix of the fibers. In one embodiment the scrubber or sponge is a composition of matter for cleaning consisting of coconut fiber, cotton fiber and turmeric distributed in the matrix of the fibers. In one embodiment the scrubber or sponge is a composition of matter for cleaning consisting of pine straw, cotton fiber and turmeric distributed in the matrix of the fibers. In one embodiment, the scrubber or sponge is a composition of matter for cleaning consisting of loofah, cotton fiber and turmeric distributed in the matrix of the fibers. In one embodiment, the scrubber or sponge is a composition of matter for cleaning consisting of natural wood shavings made of poplar, alder, aspen, birch, pine, spruce, oak, and beech wood, cotton fiber and turmeric distributed in the matrix of the fibers. In one embodiment, the scrubber or sponge is a composition of matter for cleaning consisting of shredded wood wool make of poplar, alder, aspen, birch, pine, spruce, oak, and beech wood, cotton fiber and turmeric distributed in the matrix of the fibers.

In some preferred embodiments the scrubber or sponge is a composition of matter for cleaning consisting of cellulosic fibers and curcumin wherein the curcumin is distributed on the fibers. In some preferred embodiments the scrubber or sponge is a composition of matter for cleaning consisting of cellulosic fibers and curcumin wherein the curcumin is distributed on the fibers and released in a controlled manner over time. In some preferred embodiments the scrubber or sponge is a composition of matter for cleaning consisting of cellulosic fibers, soap and curcumin wherein the curcumin is distributed on the fibers and released during use from the soap or detergent matrix.

In one embodiment the scrubber or sponge is a composition of matter for cleaning consisting of excelsior fiber, cotton fiber and a 0.01 to 10,000 μg/gm fiber concentration of curcumin distributed in the matrix of the fibers. The curcumin may be applied to a sponge added as ground turmeric powder or purified curcumin. In one embodiment the scrubber or sponge is a composition of matter for cleaning consisting of rice husks, cotton fiber and a 0.01 to 10,000 μg/gm fiber concentration of curcumin distributed in the matrix of the fibers. In one embodiment the scrubber or sponge is a composition of matter for cleaning consisting of oat straw, cotton fiber and a 0.01 to 10,000 μg/gm fiber concentration of curcumin distributed in the matrix of the fibers. In one embodiment the scrubber or sponge is a composition of matter for cleaning consisting of barley straw, cotton fiber and a 0.01 to 10,000 μg/gm fiber concentration of curcumin distributed in the matrix of the fibers. In one embodiment the scrubber or sponge is a composition of matter for cleaning consisting of coconut fiber, cotton fiber and a 0.01 to 10,000 μg/gm fiber concentration of curcumin distributed in the matrix of the fibers. In one embodiment the scrubber or sponge is a composition of matter for cleaning consisting of pine straw, cotton fiber and a 0.01 to 10,000 μg/gm fiber concentration of curcumin distributed in the matrix of the fibers. In one embodiment the scrubber or sponge is a composition of matter for cleaning consisting of loofah, cotton fiber and a 0.01 to 10,000 μg/gm fiber concentration of curcumin distributed in the matrix of the fibers. In one embodiment the scrubber or sponge is a composition of matter for cleaning consisting of natural wood shavings made of poplar, alder, aspen, birch, pine, spruce, oak, and beech wood, cotton fiber and a 0.01 to 10,000 μg/gm fiber concentration of curcumin distributed in the matrix of the fibers. In one embodiment the scrubber or sponge is a composition of matter for cleaning consisting of shredded wood wool made of poplar, alder, aspen, birch, pine, spruce, oak, and beech wood, cotton fiber and a 0.01 to 10,000 μg/gm fiber concentration of curcumin distributed in the matrix of the fibers.

In one embodiment the scrubber or sponge is a composition of matter for cleaning consisting of a cellulose matrix and a 0.01 to 10,000 μg/gm fiber concentration of curcumin distributed in the matrix of the fibers. In one embodiment the scrubber or sponge is a composition of matter for cleaning consisting of a synthetic polymer foam and a 0.01 to 10,000 μg/gm fiber concentration of curcumin distributed in the matrix of the fibers.

In one embodiment the scrubber looks like a hand-sized thin cleaning pad. In one embodiment the scrub looks like a 4″ by 6″, 5″ by 5″ or ergonomically shaped and sized cleaning pad. The encasement or cover for the fiber and soap material is made of pure cotton. The inside is stuffed with natural wood/plant fibers (e.g., excelsior) and soap/glycerol/clay/essential oil mixture. The scrubber is flexible and malleable when wet. It can be used to wash dishes, cups, glassware, utensils, pots, and pans. It can also be used to clean countertops, sink, bathtub, and other surfaces found inside commercial and non-commercial buildings. Moreover, it can be used to wash fruits and root vegetables. The scrubber helps to remove grease, stain, and dirt, as well as stuck-on/burnt food. It has the capacity to clean approximately a full load handled by a regular household dishwasher and can last up to few days depending on usage before it needs to be replaced. The scrubber can be used to wash and exfoliate face and body.

The scrubber may also include curcumin or turmeric deposited on the fiber and mixed in the soap with or without essential oils. The scrubber is flexible and malleable when wet. It can be used to wash dishes, cups, glassware, utensils, pots, and pans. It can also be used to clean countertops, sink, bathtub, and other surfaces found inside commercial and non-commercial buildings. Moreover, it can be used to wash fruits and root vegetables. The scrubber helps to remove grease, stain, and dirt, as well as stuck-on/burnt food. It has the capacity to clean approximately a full load handled by a regular household dishwasher and can last up to few days depending on usage before it needs to be replaced. The scrubber can be used to wash and exfoliate face and body.

Other embodiments of the scrubber composition use soap mixture made from plant-derived cleaning ingredients only. Therefore, it does not contain parabens, phthalates, SLS, SLE, synthetic fragrance, mineral oil, MEA, and DEA.

The wood fibers that can be used include excelsior, wood shavings, shredded wood wool, and fibers from the outer and inner bark of poplar (e.g., aspen, cottonwood), alder, birch, pine, spruce, oak, beech wood, eucalyptus, and other trees including coconut, basswood, elm, walnut, cherry, cedar, maple, hickory, oak, and ash.

The wood/plant fibers that can be used can come from rootlets of cedar, pine, juniper, tamarack, yucca, spruce, and sage.

The plant fibers that can be used can come from stalks of stinging nettle, velvet leaf, dogbane, milkweed, fireweed, hemp, and evening primrose.

The plant fiber that can be used can come from leaves of yucca, cattail, and bulrush.

The plant fibers that can be used include cotton, manila, sisal, jute, coconut fibers, palm fibers, hemp fibers, raffia, Spanish moss, coir, papyrus, sweet grass, greenbrier, cordgrass, oat straw, barley straw, rice husks/hulls, hemp straw, wheat straw, excelsior, wood shavings, and shredded wood wool from hard and soft woods including aspen, willow, neem, cotton wood, oak, palms, poplar, pine, spruce, eucalyptus. Gourd fiber such as pumpkins, cucumbers, squash, luffa, and melons, and such, which is derived from species within the plant kingdom with required physical properties, i.e., abrasiveness and strength. These fibers can be used either singularly or as a blend.

Some strand size examples for excelsior include: Grade 1 known as superfine wood wool. The thickness of its strand measures 0.006 inches and the width of its strand measures 0.020 inches. Grade 2 is known as wood wool. The thickness of its strand measures 0.012 inches and the width of its strand measures 0.020 inches. Grade 3 is known as extra fine. The thickness of its strand measures 0.015 inches and the width of its strand measures 0.031 inches. Grade 4 is known as fine. The thickness of its strand measures 0.018 inches and the width of its strand measures 0.031 inches. Grade 5 is known as medium. The thickness of its strand measures 0.021 inches and the width of its strand measures 0.041 inches. Grade 6 is known as coarse or ribbon. The thickness of its strand measures 0.015 inches and the width of its strand measures 0.167 inches.

Other natural compositions/structures that can be used are different varieties of marine sponges or sea sponges, as well as loofah from plants.

The cover or casing is made from natural textile fibers including cotton, sisal, linen, coconut, manila hemp (abaca), coir, hemp, ramie, jute, kapoc, and ramina.

Clay is also included in some embodiments of the scrubber. Examples of clays include ball clay, bentonite, common clay, fire clay, fuller's earth, and kaolin.

Glycerol, NaCl, Na2CO3 may also be added to the scrubber as an ingredient. Curcumin or turmeric powder is included in the soap along with glycerol in some embodiments. Hydrolyzed vegetable and animal fats may be used in soap for the scrubber. Some examples of kinds of oils or fats and their hydrolyzed fatty acids that can be used are: Abyssinian oil, almond butter, almond oil, aloe butter, andiroba oil, apricot kernel oil, argan oil, avocado butter, avocado oil, babassu oil, baobab oil, beeswax, black cumin seed oil, black current seed oil, borage oil, brazil nut oil, broccoli seed oil, brassica, buriti oil, camelina seed oil, camellia oil, candelilla wax, canola oil, carrot seed oil, castor oil, cherry kern1 oil, cherry kern2 oil, chicken fat, cocoa butter, coconut oil (fractionated and non-fractionated), coffee bean oil (green and roasted), cohune oil, corn oil, cottonseed oil, cranberry seed oil, cupuacu butter, duck fat, emu oil, evening primrose oil, flax oil, ghee (from any bovine), goose fat, grapeseed oil, hazelnut oil, hemp oil, horse oil, illipe butter, japan wax, jatropha oil, jojoba oil, karanja oil, kokum butter, kpangnan butter, kukui nut oil, lanolin liquid wax, lard (pig tallow), laurel fruit oil, loofa seed oil, macadamia nut butter, macadamia nut oil, mafura butter, mango seed butter, mango seed oil, marula oil, meadowfoam oil, milk fat (any bovine), milk thistle oil, mink oil, monoi de Tahiti oil, moringa oil, mowrah butter, murumuru butter, mustard oil, neatsfoot oil, neem seed oil, nutmeg butter, oat oil, olive oil, olive oil pomace, ostrich oil, palm kernel oil, palm kernel oil flakes, palm oil, palmolein, papaya seed oil, passion fruit seed oil, pataua oil, peach kernel oil, peanut oil, pecan oil, perilla seed oil, pine tar, pistachio oil, plum kernel oil, pomegranate seed oil, poppy seed oil, pracaxi seed oil, pumpkin seed oil, rabbit fat, rapeseed oil, raspberry seed oil, red palm butter, rice bran oil, rosehip oil, sacha inchi, safflower oil, sal butter, salmon oil, saw palmetto extract, saw palmetto oil, sea buckthorn oil, sesame oil, shea butter, shea oil (fractionated), soybean oil, sunflower oil, tallow (bear, deer, goat, sheep), tamanu oil, tucuma seed butter, ucuuba butter, walnut oil, watermelon seed oil,

Fatty acids and their salts may also be directly added to the scrubber including linoleic acid, oleic acid, palmitoleic acid, ricinoleic acid, omega 3, and omega 6 fatty acids. Optionally a synthetic surfactant may be added to the scrub such as for example sodium lauryl sulfate, etc.

The preparation of a few example embodiments of the sponge or scrubber is described in the following examples below.

Example 1: Add the following ingredients to a small crock pot in the order listed: 120 ml of distilled water, 21 g of NaOH, 12.6 g of KOH, 100 g of corn oil, 40 g of castor oil, 60 g of coconut oil, Heat the crock pot to about 160° F. Mix all the ingredients with an immersion blender for 10-15 minutes until trace. Continue heating for about 1 hour. Add 30 ml of glycerin and 20 g of bentonite clay to the mixture and stir for homogeneity. Weigh out a sample of excelsior between 2-3 g. Dunk the excelsior into boiling water for 60 seconds. Set them on a towel to dry for a few minutes before applying the soap/glycerin/clay mixture. Form the scrub into a nest shape or other ergonomic shape with soap/glycerin/clay mixture applied evenly within the fiber matrix, in the front and back. Set the sample to dry for 12-48 hours in ambient air or oven dry before use.

Example 2: Add the following ingredients to a small crock pot in the order listed: 120 ml of distilled water, 21 g of NaOH, 12.6 g of KOH, 100 g of corn oil, 40 g of castor oil, 60 g of coconut oil, Heat the crock pot to about 160° F. Mix all the ingredients with an immersion blender for 10-15 minutes until trace. Continue heating for about 1 hour. Add 30 ml of glycerin, 10 g of bentonite clay, and 1 g of essential oils to the mixture and stir for homogeneity. Weigh out a sample of excelsior about 2-3 g. Dunk the excelsior into boiling water for 60 seconds. Set them on a towel to dry for a few minutes before applying the soap/glycerin/clay/essential oil mixture. Stuff the excelsior with the soap mixture into a cotton gauze casing measuring 3 inches by 4.5 inches. The casing is then sewn shut with cotton thread. Set the sample to dry for 12-48 hours in ambient air or oven dry before use.

Example 3: Weigh out a sample of excelsior about 2-3 g. Stuff the excelsior into a cotton gauze casing measuring 3 inches by 4.5 inches. The casing is then sewn shut with cotton thread. The entire scrubber is then submerged in a turmeric solution for five minutes before removal to dry in ambient air or oven dry. The turmeric solution consists of 0.5 g turmeric, 20 ml of rubbing alcohol, and 1 liter of tap water.

Example 4: Add the following ingredients to a small crock pot in the order listed: 120 ml of distilled water, 21 g of NaOH, 12.6 g of KOH, 100 g of corn oil, 40 g of castor oil, 60 g of coconut oil, Heat the crock pot to about 160° F. Mix all the ingredients with an immersion blender for 10-15 minutes until trace. Continue heating for about 1 hour. Add 30 ml of glycerin, 2.5 g of curcumin, 10 g of bentonite clay, and 1 g of essential oils to the mixture and stir for homogeneity. Weigh out a sample of excelsior about 2-3 g. Cut a cotton gauze casing measuring 3 inches by 4.5 inches. Submerge the excelsior and the cotton gauze casing separately in a turmeric solution for five minutes. Remove both the excelsior and the cotton gauze casing to dry in ambient air or oven dry. Once dry, stuff the excelsior into the cotton gauze casing, along with the soap mixture. The casing is then sewn shut with cotton thread. The turmeric solution consists of 0.5 g turmeric, 20 ml of rubbing alcohol, and 1 liter of tap water.

Example 5: Weigh out a sample of excelsior about 2-3 g. Stuff the excelsior into a cotton gauze casing measuring 3 inches by 4.5 inches. The casing is then sewn shut with cotton thread. The entire scrubber is then submerged in a turmeric solution for five minutes before removal to dry in ambient air or oven dry. The turmeric solution consists of 2 g turmeric, 250 ml of acetone, and 750 ml of tap water. The weight of the scrubber increased by approximately 0.08 g after the application of the turmeric.

Example 6: Add the following ingredients to a small crock pot in the order listed: 120 ml of distilled water, 21 g of NaOH, 12.6 g of KOH, 100 g of corn oil, 40 g of castor oil, 60 g of coconut oil, Heat the crock pot to about 160° F. Mix all the ingredients with an immersion blender for 10-15 minutes until trace. Continue heating for about 1 hour. Add 30 ml of glycerin, 2.5 g of curcumin, 10 g of bentonite clay, and 1 g of essential oils to the mixture and stir for homogeneity. Weigh out a sample of excelsior about 2-3 g. Cut a cotton gauze casing measuring 3 inches by 4.5 inches. Submerge the excelsior and the cotton gauze casing separately in a turmeric solution for five minutes. Remove both the excelsior and the cotton gauze casing to dry in ambient air or oven dry. Once dry, stuff the excelsior into the cotton gauze casing, along with the soap mixture. The casing is then sewn shut with cotton thread. The turmeric solution consists of 2 g turmeric, 250 ml of rubbing alcohol, and 750 ml of tap water. The weight of the scrubber increased by approximately 0.08 g after the application of the turmeric.

What is claimed is:

1. A method of inhibiting microbial growth on a cleaning scrubber comprising treating the sponge with an effective amount of curcumin.

2. A method of claim 1 where said cleaning sponge is made of biobased polymers selected from cotton, manila, sisal, jute, coconut fibers, palm fibers, hemp fibers, raffia, gourd fibers, spanish moss, coir, papyrus, sweet grass, greenbrier, cordgrass, oat straw, barley straw, rice husks/hulls, hemp straw, wheat straw, excelsior, wood shavings, and shredded wood wool from hard and soft woods including aspen, willow, neem, cotton wood, oak, palms, poplar, pine, spruce, eucalyptus.

3. A method of claim 2 where the biobased polymer is selected from the group consisting of cellulose fiber, silk fiber or wool fiber.

4. A method of claim 1 where the cleaning sponge contains detergent or soap comprising hydrolyzed fatty acid, glycerol and curcumin.

5. A Composition of matter comprising curcumin, a plant-textile fiber, and minimally processed plant fiber.

6. A composition of claim 5 where the plant fiber is selected from cotton, manila, sisal, jute, coconut fibers, palm fibers, hemp fibers, raffia, gourd fibers, spanish moss, coir, papyrus, sweet grass, greenbrier, cordgrass, oat straw, barley straw, rice husks/hulls, hemp straw, wheat straw, excelsior and shavings from hard and soft woods including aspen, willow, neem, cotton wood, oak, palms, poplar, pine, spruce, eucalyptus.

7. A composition of claim 5 further comprising a detergent soap containing curcumin.

8. A composition of claim 7 wherein the amount of curcumin is effective in inhibiting microbial growth in a cleaning sponge.

9. A composition of claim 5 further comprising glycerol, clay and an essential oil.

10. A composition of claim 1 comprising glycerol.

11. A composition of claim 1 comprising NaCl.

12. A composition of claim 1 comprising a clay.

13. A composition of claim 1 comprising a bentonite clay.

14. A composition of claim 1 comprising excelsior as the fiber.

15. A method of making a cleaning scrubber comprising:
a. Selecting natural fibers of suitable length and strength
b. Mixing said fibers with a hydrolyzed fatty acid and optional clay
c. Shaping said fibers mixed with soap and optional ingredients like clay and essential oils into an ergonomic shape
d. Stuffing said fibers mixed with soap and optional ingredients like curcumin, clay and essential oils into a cotton gauze casing before sewing shut the casing with cotton thread.
e. Drying said cleansing scrubber to remove excessive water to attain desired moisture content

16. A method of claim 15 where a starch, gelatin, natural or synthetic glue mixed with curcumin is added.

17. A method of claim 15 where the plant fiber is selected from cotton, manila, sisal, jute, coconut fibers, palm fibers, hemp fibers, raffia, gourd fibers, spanish moss, coir, papyrus, sweet grass, greenbrier, cordgrass, oat straw, barley straw, rice husks/hulls, hemp straw, wheat straw, excelsior and shavings from hard and soft woods including aspen, willow, neem, cotton wood, oak, palms, poplar, pine, spruce, eucalyptus.

18. A method of claim 15 where the plant fiber is turmeric treated rice husk/hull.

19. A method of claim 15 where the plant fiber is turmeric treated rice husk/hull plus excelsior stuffed scrubber.

20. A method of claim 15 where the plant fiber is turmeric treated rice husk/hull plus oat straw stuffed scrubber.
